(19) United States
(12) Patent Application Publication
(10) Pub. No.: US 2025/0251248 A1
(43) Pub. Date: Aug. 7, 2025

(54) SECURITY DEVICE INTELLIGENCE FOR PUBLIC SAFETY SERVICES

(71) Applicant: Tyco Fire & Security GmbH, Neuhausen am Rheinfall (CH)

(72) Inventors: Jason M. OUELLETTE, Leominster, MA (US); Nathan Scott FLOYD, Neuhausen am Rheinfall (CH); Jason PROBALA, Neuhausen am Rheinfall (CH); Ozgur ARAL, Newbury Park, CA (US); Thibaut DE BOCK, Spring Hill, TN (US); James Lee BAUERLE, JR., Carmel, IN (US); Elyas Jeffrey SHANAB, Neuhausen am Rheinfall (CH); Victoria Viktorovna KULIKOU, Neuhausen am Rheinfall (CH)

(21) Appl. No.: 19/046,396

(22) Filed: Feb. 5, 2025

Related U.S. Application Data
(60) Provisional application No. 63/549,904, filed on Feb. 5, 2024.

(51) Int. Cl. G01C 21/34; G01C 21/36

(52) U.S. Cl. CPC G01C 21/3461; G01C 21/3676

(57) ABSTRACT

Example implementations include a method, apparatus and computer-readable medium of generating a graphical user interface (GUI), comprising receiving destination information associated with a destination location. The implementations further include determining a current geographic location. Additionally, the implementations further include transmitting a route request including the current geographic location and the destination location. Additionally, the implementations further include receiving GUI data in response to the route request, wherein the GUI data includes map data associated with one or more geographic areas between the current geographic location and the destination location, security device data for one or more security devices having a coverage area within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective coverage areas of the one or more security devices. Additionally, the implementations further include presenting the GUI on a display device, wherein the GUI includes a map representation based on the map data and one more safe route representations corresponding to the identification of the one or more safe routes.

Example implementations include a method, apparatus and computer-readable medium of generating a graphical user interface (GUI), comprising receiving a route request including a current geographic location associated with a user device and a destination location. The implementations further include obtaining map information associated with one or more geographic areas between the current geographic location and the destination location. Additionally, the implementations further include obtaining security device data for one or more security devices having a coverage area within the one or more geographic areas between the current geographic location and the destination location. Additionally, the implementations further include generating one or more travel paths through the one or more geographic areas between the current geographic location and the destination location. Additionally, the implementations further include identifying one or more safe routes among the one or more travel paths based on an amount of coverage of each travel path by respective coverage areas of the one or more security devices. Additionally, the implementations further include transmitting GUI data configured to generate the GUI on the user device in response to the route request, wherein the GUI data includes map data associated with the one or more geographic areas between the current geographic location and the destination location, security device data for the one or more security devices having the coverage area within the one or more geographic areas between the current geographic location and the destination location, one or more travel paths through the one or more geographic areas between the current geographic location and the destination location, and identification information indicating the one or more safe routes among the one or more travel paths based on the amount of coverage of each travel path by the respective coverage areas of the one or more security devices.

Example implementations include a method, apparatus and computer-readable medium of generating a graphical user interface (GUI), comprising receiving a security device information request including a current geographic location associated with a user device and a destination location. The implementations further include obtaining security device data for one or more security devices having a coverage area within one or more geographic areas between the current geographic location and the destination location. Additionally, the implementations further include transmitting GUI data configured to generate the GUI on the user device in response to the security device information request, wherein the GUI data includes security device data for one or more security devices having a field of view within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective fields of view of the one or more security devices.

### CROSS-REFERENCE TO RELATED APPLICATION

This patent application claims the benefit of U.S. Provisional Application No. 63/549,904, filed on Feb. 5, 2024, titled “SECURITY DEVICE INTELLIGENCE FOR PUBLIC SAFETY SERVICES.” The disclosure of the prior application is hereby incorporated by reference in its entirety.

### BACKGROUND

### Technical Field

The described aspects relate to increasing public safety by improving awareness of secure areas for safe movement.

### Introduction

Aspects of the present disclosure relate generally to virtual safety mapping of physical locations in the real world for use in connection with wireless communication systems, and more particularly, to virtual mapping using physical security devices and identifying safe routes for travel.

When moving through public areas in the physical world, people, including young adults, families, females, or others who may be at risk of exploitation, generally do not know the location of security devices that may be present in a particular area and provide a measure of safety and/or peace of mind, such as cameras, audio recording equipment, sensors, or other equipment. This lack of knowledge about the location of security devices may result in people selecting a route and traveling through an area that is less safe than they might otherwise choose with better information, especially if they are unfamiliar with the area.

Security devices can also be useful to government personnel and first responders in emergency situations in the physical world and can record data regarding information that the security device is configured to monitor. However, security devices are generally limited by their physical capabilities and particularities of their installation/setup, such as a security camera only being able to capture a specific field of view to a certain distance in a particular resolution. As a result of these limitations, security devices may provide an incomplete or limited record of events which they are configured to record and dangerous or illicit activities may go unrecorded.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of generating a graphical user interface (GUI), comprising receiving destination information associated with a destination location. The method further includes determining a current geographic location. Additionally, the method further includes transmitting a route request including the current geographic location and the destination location. Additionally, the method further includes receiving GUI data in response to the route request, wherein the GUI data includes map data associated with one or more geographic areas between the current geographic location and the destination location, security device data for one or more security devices having a coverage area within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective coverage areas of the one or more security devices. Additionally, the method further includes presenting the GUI on a display device, wherein the GUI includes a map representation based on the map data and one more safe route representations corresponding to the identification of the one or more safe routes.

Another example aspect includes an apparatus for generating a graphical user interface (GUI), comprising one or more memories and one or more processors coupled with the one or more memories. The one or more processors are configured to receive destination information associated with a destination location. The one or more processors are further configured to determine a current geographic location. Additionally, the processor further configured to transmit a route request including the current geographic location and the destination location. Additionally, the one or more processors are further configured to receive GUI data in response to the route request, wherein the GUI data includes map data associated with one or more geographic areas between the current geographic location and the destination location, security device data for one or more security devices having a coverage area within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective coverage areas of the one or more security devices. Additionally, the one or more processors are further configured to present the GUI on a display device, wherein the GUI includes a map representation based on the map data and one more safe route representations corresponding to the identification of the one or more safe routes.

Another example aspect includes an apparatus for generating a graphical user interface (GUI), comprising means for receiving destination information associated with a destination location. The apparatus further includes means for determining a current geographic location. Additionally, the apparatus further includes means for transmitting a route request including the current geographic location and the destination location. Additionally, the apparatus further includes means for receiving GUI data in response to the route request, wherein the GUI data includes map data associated with one or more geographic areas between the current geographic location and the destination location, security device data for one or more security devices having a coverage area within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective coverage areas of the one or more security devices. Additionally, the apparatus further includes means for presenting the GUI on a display device, wherein the GUI includes a map representation based on the map data and one more safe route representations corresponding to the identification of the one or more safe routes.

Another example aspect includes a computer-readable medium having instructions stored thereon of generating a graphical user interface (GUI), wherein the instructions are executable by one or more processors to receive destination information associated with a destination location. The instructions are further executable to determine a current geographic location. Additionally, the instructions are further executable to transmit a route request including the current geographic location and the destination location. Additionally, the instructions are further executable to receive GUI data in response to the route request, wherein the GUI data includes map data associated with one or more geographic areas between the current geographic location and the destination location, security device data for one or more security devices having a coverage area within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective coverage areas of the one or more security devices. Additionally, the instructions are further executable to present the GUI on a display device, wherein the GUI includes a map representation based on the map data and one more safe route representations corresponding to the identification of the one or more safe routes.

An example aspect includes a method of generating a graphical user interface (GUI), comprising receiving a route request including a current geographic location associated with a user device and a destination location. The method further includes obtaining map information associated with one or more geographic areas between the current geographic location and the destination location. Additionally, the method further includes obtaining security device data for one or more security devices having a coverage area within the one or more geographic areas between the current geographic location and the destination location. Additionally, the method further includes generating one or more travel paths through the one or more geographic areas between the current geographic location and the destination location. Additionally, the method further includes identifying one or more safe routes among the one or more travel paths based on an amount of coverage of each travel path by respective coverage areas of the one or more security devices. Additionally, the method further includes transmitting GUI data configured to generate the GUI on the user device in response to the route request, wherein the GUI data includes map data associated with the one or more geographic areas between the current geographic location and the destination location, security device data for the one or more security devices having the coverage area within the one or more geographic areas between the current geographic location and the destination location, one or more travel paths through the one or more geographic areas between the current geographic location and the destination location, and identification information indicating the one or more safe routes among the one or more travel paths based on the amount of coverage of each travel path by the respective coverage areas of the one or more security devices.

Another example aspect includes an apparatus for generating a graphical user interface (GUI), comprising a memory and one or more memories and one or more processors coupled with the one or more memories. The one or more processors are configured to receive a route request including a current geographic location associated with a user device and a destination location. The one or more processors are further configured to obtain map information associated with one or more geographic areas between the current geographic location and the destination location. Additionally, the one or more processors are further configured to obtain security device data for one or more security devices having a coverage area within the one or more geographic areas between the current geographic location and the destination location. Additionally, the one or more processors are further configured to generate one or more travel paths through the one or more geographic areas between the current geographic location and the destination location. Additionally, the one or more processors are further configured to identify one or more safe routes among the one or more travel paths based on an amount of coverage of each travel path by respective coverage areas of the one or more security devices. Additionally, the one or more processors are further configured to transmit GUI data configured to generate the GUI on the user device in response to the route request, wherein the GUI data includes map data associated with the one or more geographic areas between the current geographic location and the destination location, security device data for the one or more security devices having the coverage area within the one or more geographic areas between the current geographic location and the destination location, one or more travel paths through the one or more geographic areas between the current geographic location and the destination location, and identification information indicating the one or more safe routes among the one or more travel paths based on the amount of coverage of each travel path by the respective coverage areas of the one or more security devices.

Another example aspect includes an apparatus for generating a graphical user interface (GUI), comprising means for receiving a route request including a current geographic location associated with a user device and a destination location. The apparatus further includes means for obtaining map information associated with one or more geographic areas between the current geographic location and the destination location. Additionally, the apparatus further includes means for obtaining security device data for one or more security devices having a coverage area within the one or more geographic areas between the current geographic location and the destination location. Additionally, the apparatus further includes means for generating one or more travel paths through the one or more geographic areas between the current geographic location and the destination location. Additionally, the apparatus further includes means for identifying one or more safe routes among the one or more travel paths based on an amount of coverage of each travel path by respective coverage areas of the one or more security devices. Additionally, the apparatus further includes means for transmitting GUI data configured to generate the GUI on the user device in response to the route request, wherein the GUI data includes map data associated with the one or more geographic areas between the current geographic location and the destination location, security device data for the one or more security devices having the coverage area within the one or more geographic areas between the current geographic location and the destination location, one or more travel paths through the one or more geographic areas between the current geographic location and the destination location, and identification information indicating the one or more safe routes among the one or more travel paths based on the amount of coverage of each travel path by the respective coverage areas of the one or more security devices.

Another example aspect includes a computer-readable medium having instructions stored thereon of generating a graphical user interface (GUI), wherein the instructions are executable by one or more processors to receive a route request including a current geographic location associated with a user device and a destination location. The instructions are further executable to obtain map information associated with one or more geographic areas between the current geographic location and the destination location. Additionally, the instructions are further executable to obtain security device data for one or more security devices having a coverage area within the one or more geographic areas between the current geographic location and the destination location. Additionally, the instructions are further executable to generate one or more travel paths through the one or more geographic areas between the current geographic location and the destination location. Additionally, the instructions are further executable to identify one or more safe routes among the one or more travel paths based on an amount of coverage of each travel path by respective coverage areas of the one or more security devices. Additionally, the instructions are further executable to transmit GUI data configured to generate the GUI on the user device in response to the route request, wherein the GUI data includes map data associated with the one or more geographic areas between the current geographic location and the destination location, security device data for the one or more security devices having the coverage area within the one or more geographic areas between the current geographic location and the destination location, one or more travel paths through the one or more geographic areas between the current geographic location and the destination location, and identification information indicating the one or more safe routes among the one or more travel paths based on the amount of coverage of each travel path by the respective coverage areas of the one or more security devices.

An example aspect includes a method of generating a graphical user interface (GUI), comprising receiving a security device information request including a current geographic location associated with a user device and a destination location. The method further includes obtaining security device data for one or more security devices having a coverage area within one or more geographic areas between the current geographic location and the destination location. Additionally, the method further includes transmitting GUI data configured to generate the GUI on the user device in response to the security device information request, wherein the GUI data includes security device data for one or more security devices having a field of view within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective fields of view of the one or more security devices.

Another example aspect includes an apparatus for generating a graphical user interface (GUI), comprising a memory and one or more memories and one or more processors coupled with the one or more memories. The one or more processors are configured to receive a security device information request including a current geographic location associated with a user device and a destination location. The one or more processors are further configured to obtain security device data for one or more security devices having a coverage area within one or more geographic areas between the current geographic location and the destination location. Additionally, the one or more processors are further configured to transmit GUI data configured to generate the GUI on the user device in response to the security device information request, wherein the GUI data includes security device data for one or more security devices having a field of view within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective fields of view of the one or more security devices.

Another example aspect includes an apparatus for generating a graphical user interface (GUI), comprising means for receiving a security device information request including a current geographic location associated with a user device and a destination location. The apparatus further includes means for obtaining security device data for one or more security devices having a coverage area within one or more geographic areas between the current geographic location and the destination location. Additionally, the apparatus further includes means for transmitting GUI data configured to generate the GUI on the user device in response to the security device information request, wherein the GUI data includes security device data for one or more security devices having a field of view within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective fields of view of the one or more security devices.

Another example aspect includes a computer-readable medium having instructions stored thereon of generating a graphical user interface (GUI), wherein the instructions are executable by one or more processors to receive a security device information request including a current geographic location associated with a user device and a destination location. The instructions are further executable to obtain security device data for one or more security devices having a coverage area within one or more geographic areas between the current geographic location and the destination location. Additionally, the instructions are further executable to transmit GUI data configured to generate the GUI on the user device in response to the security device information request, wherein the GUI data includes security device data for one or more security devices having a field of view within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective fields of view of the one or more security devices.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is an example diagram of a graphical user interface (GUI) showing security device locations and coverage, as well as suggested travel paths, and related information;

FIG. 2 is an example diagram of a security device mapping system architecture;

FIG. 3 is a flowchart of an example of a method of user device route determination;

FIG. 4 is a flowchart of an example of a method of a mapping server receiving a route determination request from a user device and responding with one or more safe routes;

FIG. 5 is a block diagram of an example of a user device having components configured to perform a method of generating a graphical user interface (GUI);

FIG. 6 is a flowchart of an example of a method of generating a graphical user interface (GUI);

FIG. 7 is a flowchart of additional aspects of the method of FIG. 6;

FIG. 8 is a flowchart of additional aspects of the method of FIG. 6;

FIG. 9 is a flowchart of additional aspects of the method of FIG. 6.

FIG. 10 is a block diagram of an example of a user device having components configured to perform a method of generating a graphical user interface (GUI);

FIGS. 11A and 11B are a flowchart of an example of a method of generating a graphical user interface (GUI);

FIG. 12 is a flowchart of additional aspects of the method of FIG. 11;

FIG. 13 is a flowchart of additional aspects of the method of FIG. 11;

FIG. 14 is a flowchart of additional aspects of the method of FIG. 11;

FIG. 15 is a flowchart of additional aspects of the method of FIG. 11;

FIG. 16 is a flowchart of additional aspects of the method of FIG. 11.

FIG. 17 is a block diagram of an example of a user device having components configured to perform a method of generating a graphical user interface (GUI);

FIG. 18 is a flowchart of an example of a method of generating a graphical user interface (GUI);

FIG. 19 is a flowchart of additional aspects of the method of FIG. 18;

FIG. 20 is a flowchart of additional aspects of the method of FIG. 18;

FIG. 21 is a flowchart of additional aspects of the method of FIG. 18; and

FIG. 22 is a flowchart of additional aspects of the method of FIG. 18.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Aspects described herein include systems, methods, and apparatuses that can improve public safety through the identification and dissemination of information regarding the location, direction of monitoring, and capabilities of security devices in public areas in the real world. This information can be used to help members of the public make informed choices about one or more directions and routes they may take to a selected destination. With this information, an individual can securely move through a real world environment with the knowledge that any dangerous or emergency situation is likely to be monitored and/or recorded by one or more security devices on the way to the individual's destination. These recordings can be used in any number of ways by law enforcement, first responders, or others and can even help to deter crime in specific areas, since criminals may be less likely to harass or perpetrate crimes against victims if the criminals know that their actions are being recorded by security devices.

In some aspects, security devices such as video surveillance cameras provide a limited set of information through publicly consumable communications, including Bluetooth, Near Field Communications (NFC), Ultra-Wide Band (UWB), Wi-Fi, RFID, or others. The limited information may not include Personal Privacy Information (such as personally identifiable information or PII) associated with the camera and its owner(s) and/or operator(s). In the case of video camera surveillance, information about a camera can include camera attributes such as a physical location (i.e., a GIS Pin), a lens direction, field of view (FOV), features (e.g., zoom, lens filter(s) frame rate capture, integration with emergency systems, and/or other physical or programmed features), and other non-PII information. The information can be transmitted to a cloud agent via one or more networking components over one or more wired and/or wireless communications networks using one or more communications protocols and stored in or at a repository. At the repository, a cloud agent can collect and store the information in one or more databases. In some aspects, the information can be stored in the one or more databases in association with one or more tags and/or metadata (exclusive of PII). The information can be dynamic in various aspects and each device can have its own Global Unique Identification (GUID) number to maintain uniqueness. Smartphones, wireless access points (WAPs), receivers, and/or other communications devices can receive broadcasts from security devices (e.g., in a similar manner to electronic tags), and the non-PII security information can be sent to the cloud agent for update and/or storage.

Some aspects provide for one or more digital subscription services to be provided to developers, such as virtual map developers. These virtual map developers, in turn, may allow individual end-users (e.g., consumers, members of the public, or other individuals who may desire or require map services) and/or institutions (e.g., public or private concerns, such as business security, police, emergency service providers (i.e., fire departments or medical service providers), or other security focused or tangential institutions) to view one or more possible travel paths where security device coverage (e.g., audio surveillance, video surveillance, physical access control devices, and/or other control or surveillance device) exists for safety coverage. In the case of police and emergency service providers, information such as FOV captured event or incident recordings can provide evidence that is valuable in determining how an event or incident occurred or unfolded, if security devices were able to capture such event or incident.

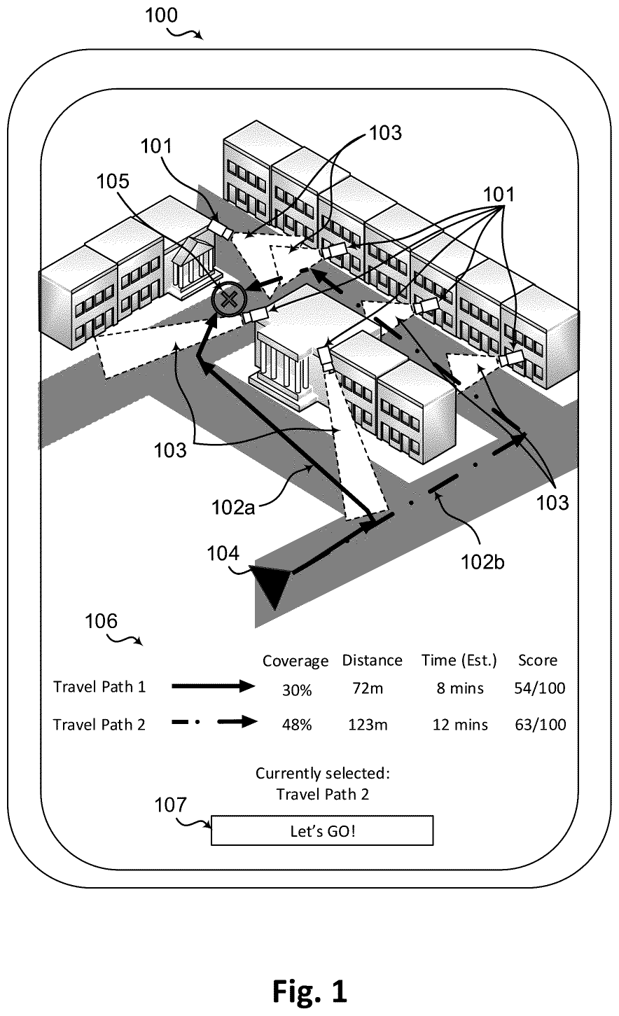

Referring to FIG. 1, a user device 100 (e.g., a smartphone, tablet, phablet, laptop, smart watch, smart glasses, heads up display (HUD), projector, vehicle integrated device (e.g., integrated with a bicycle, motorcycle, automobile, scooter, moped, or other vehicle), or other wearable, mobile, and/or transportable device) can include a user interface such as a real and/or virtual visual display that can be configured to display a virtual map and may include one or more environmental features. These environmental features can include stationary, permanent, fixed, temporary, and/or movable artificial (i.e., manmade) features (e.g., buildings, parking lots, curbs, paved and unpaved roads, trails, paths, fences, gates, statues, fountains, streetlights, traffic lights, fire hydrants, vehicles, and others) and natural features (e.g., existing terrain such as hills, mountains, ridges, cliffs, canyons, valleys, draws, ponds, lakes, streams, rivers, seashores, trees, bushes, fields, and others). Using the map, a user can enter and/or select a destination location 105. In some aspects, a start location 104 can be selected by a user and/or can be determined based on a current location of the user device. Using destination location 105 and start location 104, the system can calculate, generate, and/or otherwise determine one or more travel paths (e.g., travel path 102a depicted as a solid line and travel path 102b depicted as a dashed/dotted line) that are potential routes that a user can elect to take to travel from start location 104 to destination location 105. Calculating, generating, and/or determining the one or more paths can include the system accounting for one or more variables, which may be user selectable in some aspects. For example, a user may enter and/or select a desired departure time, a desired arrival time, a desired transit time, a most direct route (i.e., lowest travel distance), and/or other user influenced variables. Alternatively or additionally, in some aspects variables can include real world conditions such as traffic, weather, event or location avoidance, or other real world conditions. In various aspects the system also includes locations of one or more security devices 101. In some aspects, a coverage indicator 103 corresponding to one, some, or each security device 101 can be included. Coverage indicators 103 can correspond to field of view for visual security devices (e.g., still or video cameras), audio cone coverage for audio surveillance devices, or other coverage abilities for various other sensors and/or surveillance equipment that may be integrated with the system in the real world. When one or more travel paths (e.g., travel path 102a, travel path 102b) are determined, security device coverage can also be determined based on a number and estimated and/or actual coverage of such security devices. In some aspects, information 106 about each travel path can be displayed for user review. Information 106 can include, for example, security device coverage (e.g., as a percentage of the travel path, by location, with respect to proximity to the travel path, or other security device coverage information that would be useful and/or pertinent for a user), a total distance along the travel path from the start location 104 to the destination location 105, an estimated time to reach the destination along the travel path (i.e., estimated travel time), and an overall and/or total score for the travel path (e.g., as calculated based on one or more algorithms, based on one or more factors, such as safety determined by security device coverage, total distance, and/or estimated time to reach the destination). Users can select a travel path via a user interface (e.g., using radio buttons or other selection mechanism) and then select a confirmation button 107, which will begin route guidance and/or tracking.

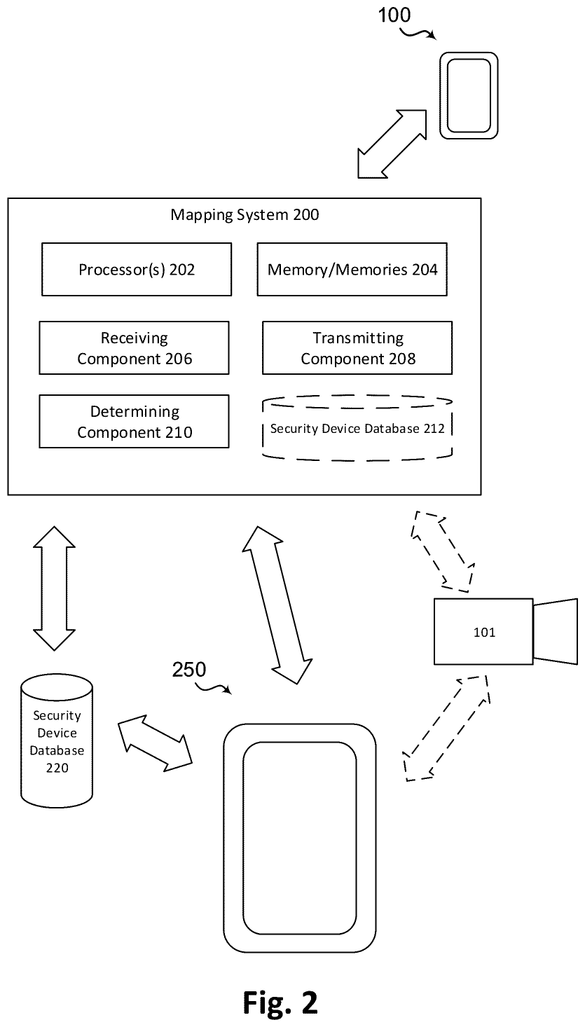

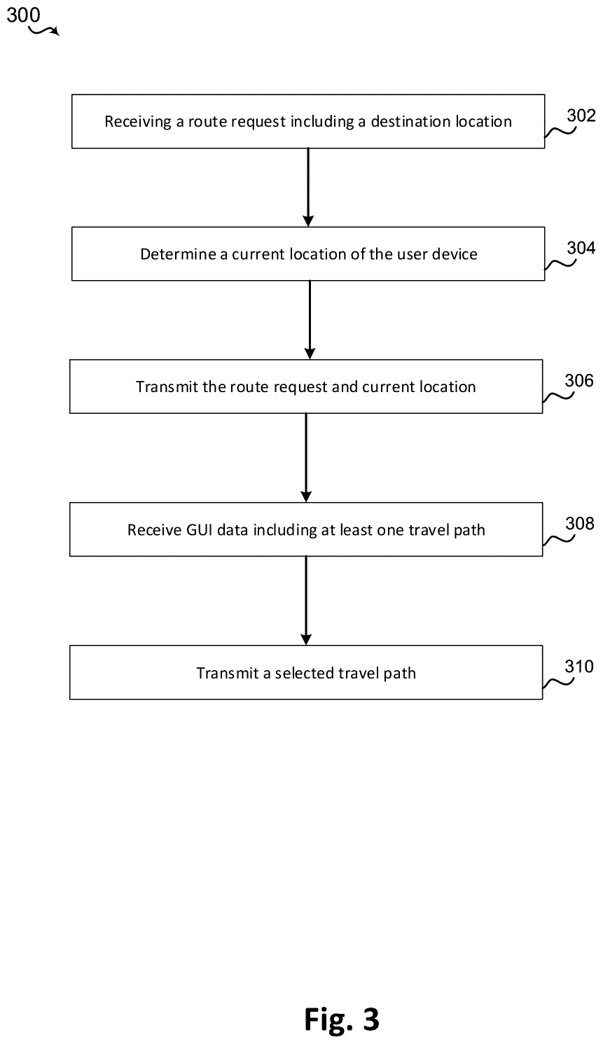

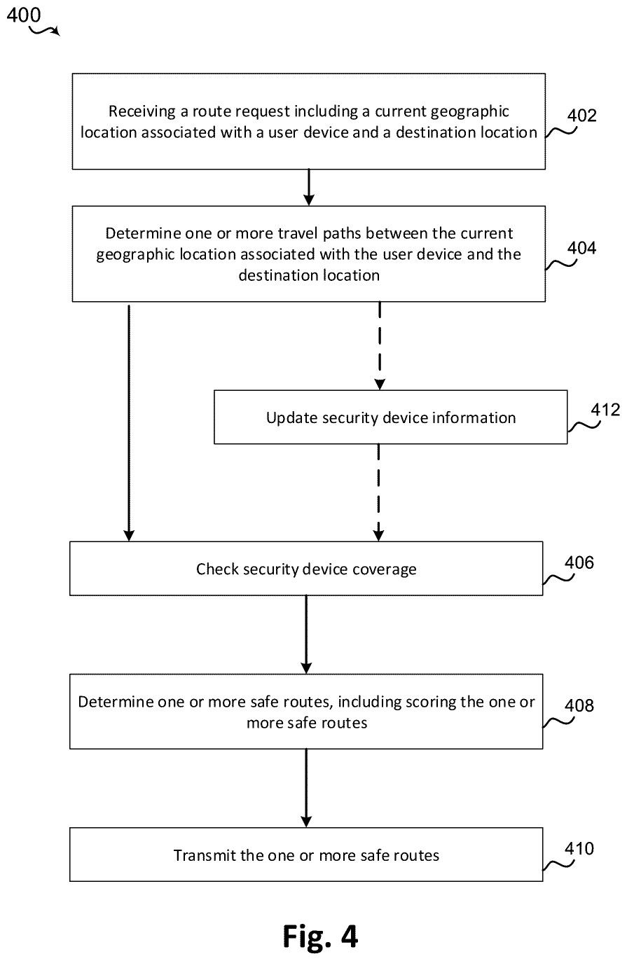

Referring to FIGS. 2-4, in some aspects, a security device mapping architecture can include a user device 250 that is used to catalog one or more security devices 101. In some aspects, a user device 250 can be owned and/or operated by a private company, government agency or department, or a member of the public. In these various aspects, user device 250 may have access to or otherwise receive data from one or more security devices 101. In such aspects, information (e.g., type, make, model, operable state, field of vision, direction, or other related information regarding the device, components, features, and/or capabilities) about the security device 101 can be transmitted to security device database 220, which may be located on a server. Alternatively or additionally, a user device 250 that is unaffiliated with an entity owning or operating a security device 101 (e.g., where the user device is owned by a member of the public), may communicate information (e.g., type, make, model, operable state, field of vision, direction, or other related information regarding the device, components, features, and/or capabilities) about the security device 101 to security device database 220.

In some aspects, user device 100 functionality can operate according to a method 300. At block 302, a user can enter a route request, including inputting a destination location via a user interface (e.g., selecting a button, typing on a touchscreen or keyboard, speaking into a microphone coupled with speech recognition, or other user interface capabilities) of a user device 100. At 304 one or more processors 105 of the user device 100 can cause a determining component 525 to determine a current geographic location using one or more geolocation functions. This determination can occur via global positioning system (GPS), cell phone towers, Wi-Fi access points, IP geolocation, or other means of electronically determining the location of a user device. Geolocation can identify latitude and longitude coordinates, other coordinates, a physical address, and/or other physical location. This can include cross-referencing coordinates and/or address or location with a map.

In various aspects, user device 250 may have access to data (e.g., video footage, images, or otherwise) captured and stored (and/or live feeds) by security device 101.

In various aspects, mapping system 200 may have access to data (e.g., video footage, images, audio, temperature, infrared or ultraviolet images or video, or other data from a security device) captured and stored (and/or live feeds) by security device 101. For example, if the security device 101 provides a live video feed of a location that is publicly accessible via a website, portal, or application, such feed may be accessible by mapping system 200 and can be provided directly or through a link for user viewing/review via a presenting component 535. Alternatively or additionally, if the security device 101 provides a privately accessible live video feed of a location, such feed may be accessible by mapping system 200 and can be provided directly or through a link for authorized user viewing/review (e.g., by emergency services personnel, government investigations personnel, private security personnel, or other authorized persons and/or entities).

At block 306, the user device 100 can transmit, via transmitting component 530, the route request and current location information to a mapping system (e.g., a mapping server) over a network via a wireless and/or wired connection.

At block 308, the user device 100 can receive, via receiving component 520, GUI data including at least one travel path from the mapping system (e.g., a mapping server). This GUI data can be displayed on the user device for review by the user and can include a variety of route information (e.g., security device coverage, travel path distances, time estimates, lighting, proximity to emergency services, scores, and other route related information related to safety and/or security).

At block 310 the user device 100 can transmit, via transmitting component 530, a selected travel path over a network via a wired and/or wireless connection to the mapping system that the user has selected. In some aspects, after receiving this selected travel path, the mapping server can provide real-time information about the user location and updates about travel path conditions or other related information to the user by transmitting such information to the user device 100 over a network via a wired and/or wireless connection.

In some aspects, mapping system functionality can operate according to a method 400. At block 402 a mapping system can receive, from a user device 100 via a network, a route request including current geographic location associated with user device 100 and a destination location that has been selected and/or inputted by a user via a user interface of the user device 100.

At block 404 the mapping system can determine one or more travel paths between the current geographic location associated with the user device 100 and the destination location. These one or more travel paths can follow various natural features (e.g., topographical contours in the land, natural boundaries formed by waterways, or others) and artificial features (e.g., roads, paths, fences, gates, or others). Alternatively or additionally, travel paths can cross natural features and artificial features. Travel paths can also be determined based on known, stored security device locations. In some aspects, block 412 can include updating security device information. For example, this can include transmitting a request for updated information to a security device information repository, accessing a security device information database, or otherwise.

After block 404 and/or after block 412, at block 406 the mapping system can check security device coverage of the one or more travel paths.

At block 408, the mapping system can determine one or more safe routes, including scoring the one or more safe routes. This can include determining an amount of coverage, such as a percentage of a travel path that is covered by security devices. In some aspects the mapping system can calculate a total coverage score. Total coverage scores for the one or more travel paths can be compared and one or more recommendations can be made of the one or more safe routes.

At block 410 the mapping system can transmit the one or more safe routes to the user device 100.

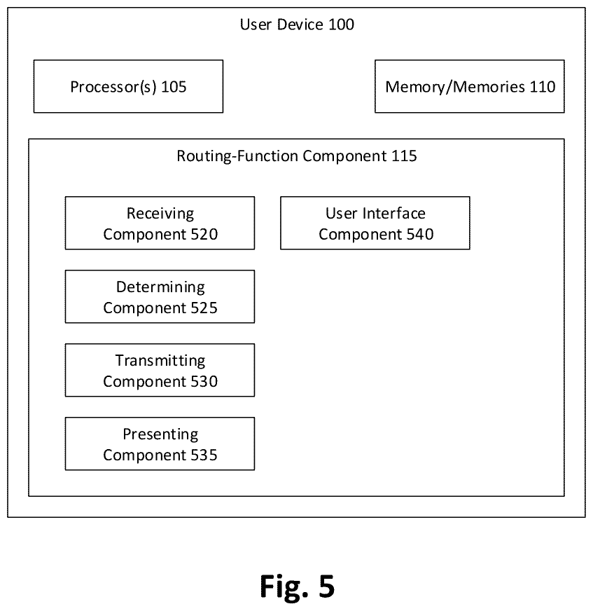

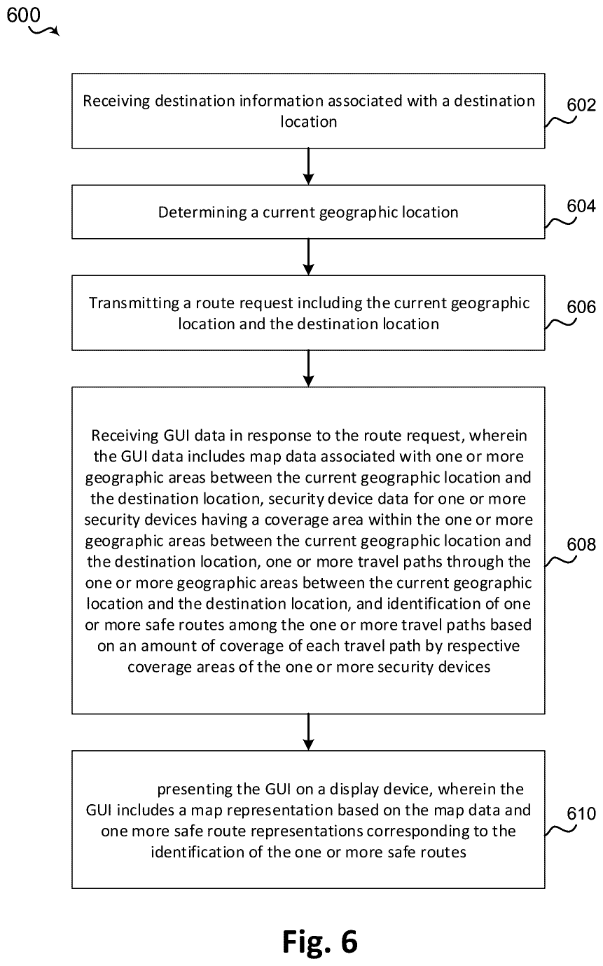

Referring to FIG. 5 and FIG. 6, in operation, user device 100 may perform a method 600 of generating a graphical user interface (GUI), such as via execution of routing-function component 115 by one or more processors 105 and/or one or more memories 110.

At block 602, the method 600 includes receiving destination information associated with a destination location. For example, in an aspect, user device 100, one or more processors 105, one or more memories 110, routing-function component 115, and/or receiving component 520 may be configured to or may comprise means for receiving destination information associated with a destination location.

For example, the receiving at block 602 may include a user entering and/or selecting a destination in a mapping program. The user can enter a destination using a user input device 100, such as by using a keyboard, mouse, touchscreen, voice recognition software, or other components to enter the destination (e.g., address, name of a location, or others) at a user device 100. As the user enters the information, the system can perform auto-populating and/or suggestion functions to assist the user in quickly entering the destination. In some aspects, such as for a bounded area or other localized mapping program, a list of frequent destinations may be displayed via presenting component 535 to the user via a user device display and the user can then select a destination from a list, by clicking on the map, or other selection mechanism via a user interface. In some aspects, intermediate destinations and/or waypoints can be selected, added, or otherwise incorporated into the mapping functionality by user command via a user interface. Once a destination has been entered and/or selected via a user interface, the system can require user confirmation to ensure that the correct destination has been entered and/or selected. Confirmation can occur via a pop-up by presenting component 535 asking the user to confirm that the entered and/or selected destination is correct via a user interface.

Further, for example, the receiving at block 602 may be performed via receiving component 520 in order for the system to determine a location where the user ultimately wants to arrive at the end of a route. In some instances, receiving destination information can occur locally on a user device, while in some aspects receiving destination can occur at a location remote to the user device 100, such as at a system server. Receiving at a location remote to the user device 100 can include the user device 100 transmitting, via transmitting component 530, the destination information via one or more wired and/or wireless networks (e.g., via the Internet) to the server for processing.

At block 604, the method 600 includes determining a current geographic location. For example, in an aspect, user device 100, one or more processors 105, one or more memories 110, routing-function component 115, and/or determining component 525 may be configured to or may comprise means for determining a current geographic location.

For example, the determining at block 604 may include identifying a current geographic location using one or more geolocation functions. This identification can occur via global positioning system (GPS), cell phone towers, Wi-Fi access points, IP geolocation, or others. Geolocation can identify latitude and longitude coordinates, other coordinates, a physical address, and/or other physical location. This can include cross-referencing coordinates and/or address or location with a map.

Further, for example, the determining at block 604 may be performed to use the determined current geographic location as an input in one or more route calculating algorithms.

At block 606, the method 600 includes transmitting a route request including the current geographic location and the destination location. For example, in an aspect, user device 100, one or more processors 105, one or more memories 110, routing-function component 115, and/or transmitting component 530 may be configured to or may comprise means for transmitting a route request including the current geographic location and the destination location via a wireless network, wired network, or combination thereof to a route calculation system. The route calculation system can include a server, user device, cloud service, and/or others.

For example, the transmitting at block 606 may include sending one or more messages including the current geographic location and/or the destination location. Such message(s) can be sent with a route request and/or in response to a message from a server.

Further, for example, the transmitting at block 606 may be performed in order for a user to inform a route determination system of start and end points for a route calculation. This can inform the system of where the user is currently located and where they want to travel to, so that the system can make calculations and/or determinations about what routes are accessible to the user.

At block 608, the method 600 includes receiving GUI data in response to the route request, wherein the GUI data includes map data associated with one or more geographic areas between the current geographic location and the destination location, security device data for one or more security devices having a coverage area within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective coverage areas of the one or more security devices. For example, in an aspect, user device 100, one or more processors 105, one or more memories 110, routing-function component 115, and/or receiving component 530 may be configured to or may comprise means for receiving GUI data in response to the route request, wherein the GUI data includes map data associated with one or more geographic areas between the current geographic location and the destination location, security device data for one or more security devices having a coverage area within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective coverage areas of the one or more security devices.

For example, the receiving at block 608 may include receiving GUI data in response to the route request this can include receiving at a receiver and/or transceiver of a user device, via a wired and/or wireless network, GUI data from a route calculation system. GUI data can include map data associated with one or more geographic areas between the current geographic location and the destination location. Map data can include information about geographic and/or other physical features existing in the physical world such as streets, paths, tracks, terrain, elevation, paving, and/or others. GUI data can also include security device data for one or more security devices having a coverage area within the one or more geographic areas between the current geographic location and the destination location. Security device data can include information about security devices such as physical locations, height, field of view, direction of view, audio monitoring capabilities, sensor information (e.g., night vision, thermal vision, spectrum information, and/or others). GUI data can also include one or more travel paths through the one or more geographic areas between the current geographic location and the destination location. Travel path information can include artificial (e.g., human produced) routes, natural routes, and/or combinations thereof. Travel path information can also include description and/or naming of any obstacles that may be encountered along the travel path (e.g., streams, statues, hills, and/or others). GUI data can also include identification of one or more safe routes among the one or more travel paths based on an amount of coverage of each travel path by respective coverage areas of the one or more security devices. Safe routes can include one or more security devices along and/or pointing in the direction or otherwise monitoring and/or capable of monitoring the travel paths. For example, public and/or private surveillance cameras, audio surveillance equipment, electronic surveillance equipment (e.g., monitoring communications and/or other radio spectrum devices), wind sensors, temperature sensors, humidity sensors, smoke sensors, fire sensors, and/or others.

Further, for example, the receiving at block 608 may be performed in order for an application and/or program running on, at, or through a user device to provide a response to the user's route request.

At block 610, the method 600 includes presenting the GUI on a display device, wherein the GUI includes a map representation based on the map data and one more safe route representations corresponding to the identification of the one or more safe routes. For example, in an aspect, user device 100, one or more processors 105, one or more memories 110, routing-function component 115, and/or presenting component 535 may be configured to or may comprise means for presenting the GUI on a display device, wherein the GUI includes a map representation based on the map data and one more safe route representations corresponding to the identification of the one or more safe routes.

For example, the presenting at block 610 may include one or more displays of the user device displaying the GUI view viewing by the user. The GUI may also be coupled with and/or otherwise integrated with audio functionality, such that an audio output component such as a speaker of the user device can provide an audio version of the route, including an overview, directions, and/or others, to the user.

Further, for example, the presenting at block 610 may be performed so that the user can review the safe route(s) in order to select between them, choose a different destination, cancel their trip, and/or otherwise make a decision based on the safe route(s) calculated by the system.

In an alternative or additional aspect, the GUI includes coverage area representations of the one or more security devices on the one or more safe route representations.

In an alternative or additional aspect, the GUI includes a security score indicator for each of the one or more safe route representations respectively, based on the amount or level of coverage of each travel path by the respective coverage areas of the one or more security devices. In this aspect, the GUI may include security device representations of the one or more security devices on the one or more geographic areas between the current geographic location and the destination location. In this aspect, the security device representations may include security device information. In this aspect, the security device information may include at least one of a geographic location information, a global unique identification (GUID) number, or non-personal identifier information associated with each respective security device.

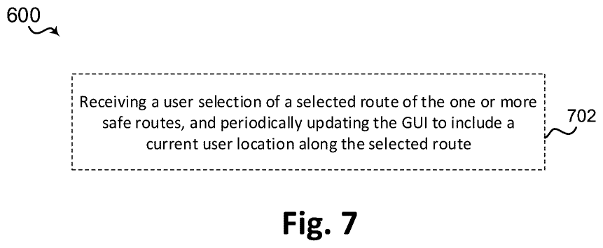

Referring to FIG. 7, in an alternative or additional aspect, at block 702, the method 600 may further include receiving a user selection of a selected route of the one or more safe routes, and periodically updating the GUI to include a current user location along the selected route. For example, in an aspect, user device 100, one or more processors 105, one or more memories 110, routing-function component 115, and/or receiving component 535 may be configured to or may comprise means for receiving a user selection of a selected route of the one or more safe routes, and periodically updating the GUI to include a current user location along the selected route.

For example, the receiving at block 702 may include a user transmitting, via the user device, a route selection, whereby the system can monitor conditions along the route in order to ensure that the route is the best route according to route criteria. Periodically updating the GUI to include a current user location can include the user device sending one or more messages including the current geographic location to the system. Such message(s) can be sent with a route request (e.g., a new route request or updated route request) and/or in response to a message from a server. In some aspects the GUI is updated according to a location determination by the user device, and the GUI displays the user location in accordance with a mapping program.

Further, for example, the transmitting at block 702 may be performed in order for the route determination system to modify and/or update a route calculation. This can inform the system of where the user is currently located and where they want to travel to, so that the system can make calculations and/or determinations about what routes are accessible to the user. In some aspects, updates can occur based on changing conditions (e.g., physical conditions such as weather, traffic, blocked routes, or electronic conditions such as one or more security devices malfunctioning and/or going offline along the route). Messages, notifications, and/or other updates can be configured to update the user about the route conditions based on triggers such as time, location, condition changes and/or others.

In an alternative or additional aspect, the one or more security devices includes at least one of a public video camera or a private video camera.

In an alternative or additional aspect, the security device data includes one or more of a line of sight, a focal length, a working distance, a lens magnification, an imaging sensor size, imaging sensor aspect ratio, or a field of view.

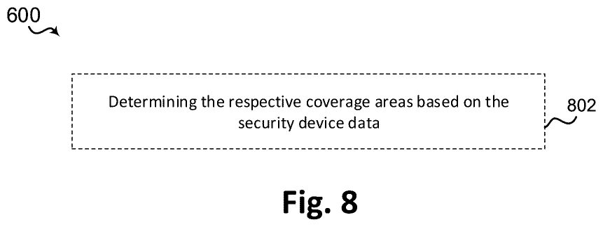

Referring to FIG. 8, in an alternative or additional aspect, at block 802, the method 600 may further include determining the respective coverage areas based on the security device data. For example, in an aspect, user device 100, one or more processors 105, one or more memories 110, routing-function component 115, and/or determining component 535 may be configured to or may comprise means for determining the respective coverage areas based on the security device data.

For example, the determining at block 802 may include using security device data to determine one or more security coverage areas. For example, certain types of security cameras may be able to capture accurate video recordings at a short distance and may constantly record, while others may record only periodically (e.g., one second of every ten seconds) but may have a longer field of view with accurate recording. In some aspects, multiple security devices can cover a single area, such that their coverage partially or fully overlaps.

Further, for example, the determining at block 802 may be performed to ensure the best security coverage, because an outage or downtime due to a malfunction or other problem or issue with one security device will not cause a full outage and lack of surveillance of an area.

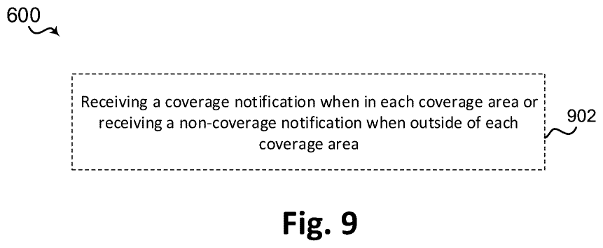

Referring to FIG. 9, in an alternative or additional aspect, at block 902, the method 600 may further include receiving a coverage notification when in each coverage area or receiving a non-coverage notification when outside of each coverage area. For example, in an aspect, user device 100, one or more processors 105, one or more memories 110, routing-function component 115, and/or receiving component 535 may be configured to or may comprise means for receiving a coverage notification when in each coverage area or receiving a non-coverage notification when outside of each coverage area.

For example, the receiving at block 902 may include the user device 100 receiving a coverage notification of one or more security devices based on a current user device location. To elaborate, when a user device current location enters a coverage area, a notification can be sent to and/or occur (e.g., an audio, visual, tactile, and/or other notification) at the user device 100. Similarly, when a user device current location exits a coverage area, a notification can be sent to and/or occur (e.g., an audio, visual, tactile, and/or other notification) at the user device 100.

Further, for example, the receiving at block 902 may be performed so that a user of the user device 100 is aware of the circumstances of their security/surveillance status along the route, due to coverage by security devices. Therefore, when the user is out of a coverage area, they may be more careful of their surroundings and/or seek to enter a coverage area.

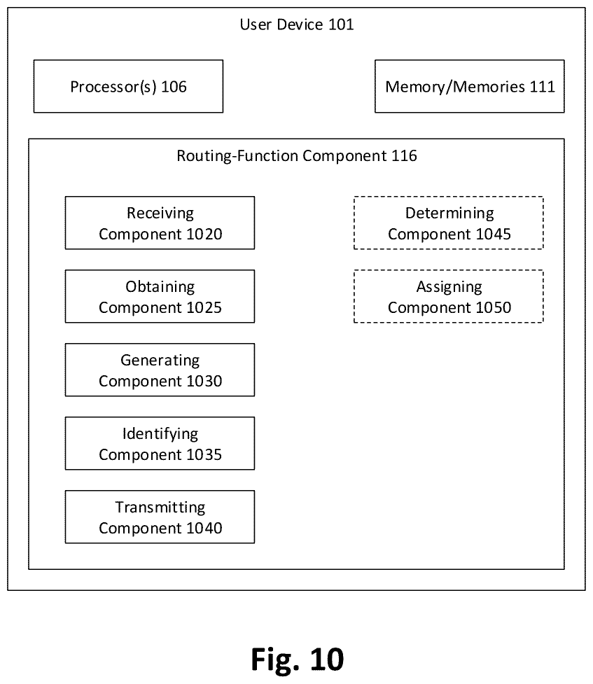

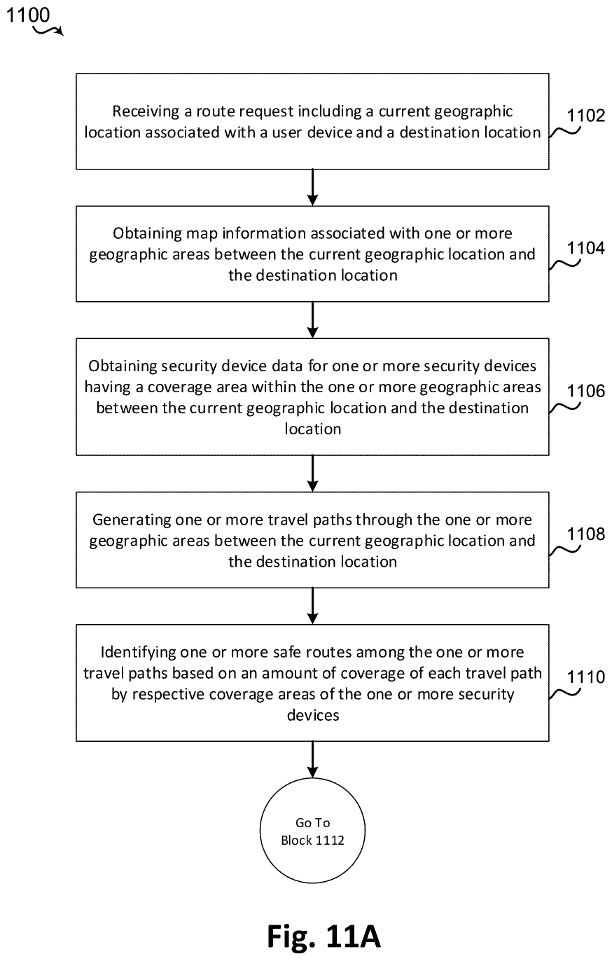

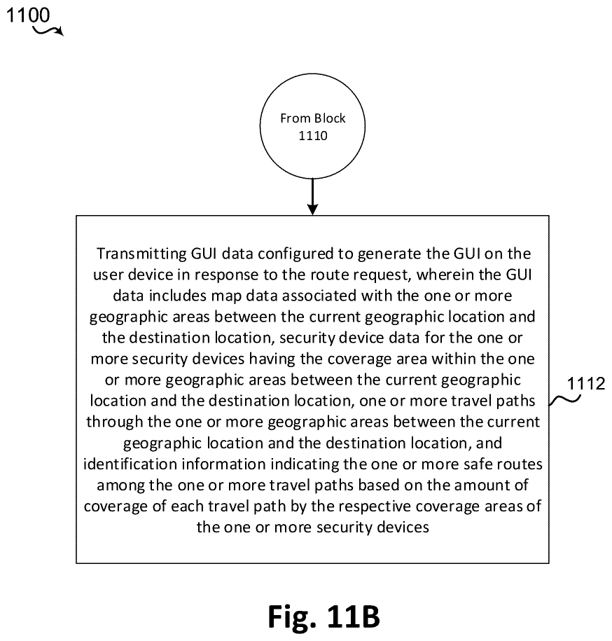

Referring to FIG. 10 and FIGS. 11A and 11B, in operation, user device 101 may perform a method 1100 of generating a graphical user interface (GUI), by such as via execution of routing-function component 116 by one or more processors 106 and/or one or more memories 111.

At block 1102, the method 1100 includes receiving a route request including a current geographic location associated with a user device and a destination location. For example, in an aspect, user device 101, one or more processors 106, one or more memories 111, routing-function component 116, and/or receiving component 1020 may be configured to or may comprise means for receiving a route request including a current geographic location associated with a user device and a destination location.

For example, the receiving at block 1102 may include identifying a current geographic location using one or more geolocation functions. This identification can occur via global positioning system (GPS), cell phone towers, Wi-Fi access points, IP geolocation, or others. Geolocation can identify latitude and longitude coordinates, other coordinates, a physical address, and/or other physical location. This can include cross-referencing coordinates and/or address or location with a map

The receiving at block 1102 may also include a user entering and/or selecting a destination in a mapping program. The user can enter a destination using a user input device such as by using a keyboard, mouse, touchscreen, voice recognition software, or other components to enter the destination (e.g., address, name of a location, or others) at a user device. As the user enters the information, the system can perform auto-populating and/or suggestion functions to assist the user in quickly entering the destination. In some aspects, such as for a bounded area or other localized mapping program, a list of frequent destinations may be displayed to the user via a user device display and the user can then select a destination from a list, by clicking on the map, or otherwise. In some aspects, intermediate destinations and/or waypoints can be selected, added, or otherwise incorporated into the mapping functionality. Once a destination has been entered and/or selected, the system can require user confirmation to ensure that the correct destination has been entered and/or selected. Confirmation can occur via a pop-up asking the user to confirm that the entered and/or selected destination is correct.

The receiving at block 1102 may also include receiving one or more messages including the current geographic location and/or the destination location. Such message(s) can be sent with a route request and/or in response to a message from a server.

Further, for example, the receiving at block 1102 may be performed to use the determined current geographic location as an input in one or more route calculating algorithms.

Further, for example, the receiving at block 1102 may also be performed in order for the system to determine a location where the user ultimately wants to arrive at the end of a route. In some instances, receiving destination information can occur locally on a user device, while in some aspects receiving destination can occur at a location remote to the user device, such as at a system server. Receiving at a location remote to the user device can include the user device transmitting the destination information via one or more wired and/or wireless networks (e.g., via the Internet) to the server for processing.

Further, for example, the receiving at block 1102 may also be performed in order for a user to inform a route determination system of start and end points for a route calculation. This can inform the system of where the user is currently located and where they want to travel to, so that the system can make calculations and/or determinations about what routes are accessible to the user.

At block 1104, the method 1100 includes obtaining map information associated with one or more geographic areas between the current geographic location and the destination location. For example, in an aspect, user device 101, one or more processors 106, one or more memories 111, routing-function component 116, and/or obtaining component 1025 may be configured to or may comprise means for obtaining map information associated with one or more geographic areas between the current geographic location and the destination location.

For example, the obtaining at block 1104 may include sending a request to a database and/or otherwise accessing a database or other map information storage location. The database or map information storage location can be stored locally or remotely and may be accessed via a network. Further, the database or map information storage location can be provided by a third-party service (e.g., public, private, commercial, governmental, or others) in some aspects, can be maintained by the system in some aspects, or otherwise be accessible.

Further, for example, the obtaining at block 1104 may be performed so that map information can be used to generate one or more maps for a user to view that shows them one or more routes and/or travel paths they can follow.

At block 1106, the method 1100 includes obtaining security device data for one or more security devices having a coverage area within the one or more geographic areas between the current geographic location and the destination location. For example, in an aspect, user device 101, one or more processors 106, one or more memories 111, routing-function component 116, and/or obtaining component 1025 may be configured to or may comprise means for obtaining security device data for one or more security devices having a coverage area within the one or more geographic areas between the current geographic location and the destination location.

For example, the obtaining at block 1106 may include sending a request to a database and/or otherwise accessing a database or other security device information storage location. The database or security device information storage location can be stored locally or remotely and may be accessed via a network. Further, the database or security device information storage location can be provided by a third-party service (e.g., public, private, commercial, governmental, or others) in some aspects, can be maintained by the system in some aspects, or otherwise be accessible. Security device data can include information about security devices such as physical locations, height, field of view, direction of view, audio monitoring capabilities, sensor information (e.g., night vision, thermal vision, spectrum information, and/or others).

Further, for example, the obtaining at block 1106 may be performed in order for the system to provide a response to the user's route request using accurate and/or up to date security device data.

At block 1108, the method 1100 includes generating one or more travel paths through the one or more geographic areas between the current geographic location and the destination location. For example, in an aspect, user device 101, one or more processors 106, one or more memories 111, routing-function component 116, and/or generating component 1030 may be configured to or may comprise means for generating one or more travel paths through the one or more geographic areas between the current geographic location and the destination location.

For example, the generating at block 1108 may include generating one or more travel paths from a current geographic location (or selected location) to a destination location that are covered by security devices. A number of criteria can be used and/or selectable by a user as inputs to one or more algorithms that are used to generate the one or more travel paths. For example, a user may wish to make the most use of paved surfaces in traveling to their destination. Alternatively or additionally, the user may wish to avoid crossing any bodies of water (e.g., streams, rivers, or ponds). Alternatively or additionally, the user may wish to travel only along urban paths with good, artificial lighting and not wish to travel through dense foliage without good, artificial lighting.

Further, for example, the generating at block 1108 may be performed in order respond to the user's route request, so that the user can reach their destination.

At block 1110, the method 1100 includes identifying one or more safe routes among the one or more travel paths based on an amount of coverage of each travel path by respective coverage areas of the one or more security devices. For example, in an aspect, user device 101, one or more processors 106, one or more memories 111, routing-function component 116, and/or identifying component 1035 may be configured to or may comprise means for identifying one or more safe routes among the one or more travel paths based on an amount of coverage of each travel path by respective coverage areas of the one or more security devices.

For example, the identifying at block 1110 may include cross-referencing the security device data for the one or more security devices with the one or more travel paths. In some aspects, cross-referencing can be used to overlay security device data on a map, so that the system can identify one or more safe routes for a user to review, which include surveillance coverage along the one or more travel paths.

Further, for example, the identifying at block 1110 may be performed so that the user route request can be replied to effectively.

At block 1112, the method 1100 includes transmitting GUI data configured to generate the GUI on the user device in response to the route request, wherein the GUI data includes map data associated with the one or more geographic areas between the current geographic location and the destination location, security device data for the one or more security devices having the coverage area within the one or more geographic areas between the current geographic location and the destination location, one or more travel paths through the one or more geographic areas between the current geographic location and the destination location, and identification information indicating the one or more safe routes among the one or more travel paths based on the amount of coverage of each travel path by the respective coverage areas of the one or more security devices. For example, in an aspect, user device 101, one or more processors 106, one or more memories 111, routing-function component 116, and/or transmitting component 1040 may be configured to or may comprise means for transmitting GUI data configured to generate the GUI on the user device in response to the route request, wherein the GUI data includes map data associated with the one or more geographic areas between the current geographic location and the destination location, security device data for the one or more security devices having the coverage area within the one or more geographic areas between the current geographic location and the destination location, one or more travel paths through the one or more geographic areas between the current geographic location and the destination location, and identification information indicating the one or more safe routes among the one or more travel paths based on the amount of coverage of each travel path by the respective coverage areas of the one or more security devices.

For example, the transmitting at block 1112 may include transmitting GUI data from a route calculation system in response to the route request using a transmitter and/or transceiver via a wired and/or wireless network. GUI data can include map data associated with one or more geographic areas between the current geographic location and the destination location. Map data can include information about geographic and/or other physical features existing in the physical world such as streets, paths, tracks, terrain, elevation, paving, and/or others. GUI data can also include security device data for one or more security devices having a coverage area within the one or more geographic areas between the current geographic location and the destination location. Security device data can include information about security devices such as physical locations, height, field of view, direction of view, audio monitoring capabilities, sensor information (e.g., night vision, thermal vision, spectrum information, and/or others). GUI data can also include one or more travel paths through the one or more geographic areas between the current geographic location and the destination location. Travel path information can include artificial (e.g., human produced) routes, natural routes, and/or combinations thereof. Travel path information can also include description and/or naming of any obstacles that may be encountered along the travel path (e.g., streams, statues, hills, and/or others). GUI data can also include identification of one or more safe routes among the one or more travel paths based on an amount of coverage of each travel path by respective coverage areas of the one or more security devices. Identification information indicating the one or more safe routes can include identification information about one or more security devices along and/or pointing in the direction or otherwise monitoring and/or capable of monitoring the travel paths. For example, public and/or private surveillance cameras, audio surveillance equipment, electronic surveillance equipment (e.g., monitoring communications and/or other radio spectrum devices), wind sensors, temperature sensors, humidity sensors, smoke sensors, fire sensors, and/or others.

Further, for example, the transmitting at block 1112 may be performed in order to provide a user with accurate information about security device coverage in response to the user's route request.

In an alternative or additional aspect, the GUI includes coverage area representations of the one or more security devices on the one or more safe routes.

In an alternative or additional aspect, the GUI includes a security score indicator for each of the one or more safe routes respectively, based on the amount of coverage of each travel path by the respective coverage areas of the one or more security devices. In this aspect, the GUI may include security device representations of the one or more security devices on the one or more geographic areas between the current geographic location and the destination location. In this aspect, the security device representations may include security device information. In this aspect, the security device information may include at least one of a geographic location information, a global unique identification (GUID) number, or non-personal identifier information associated with each respective security device.

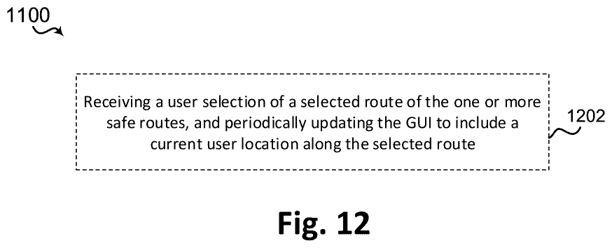

Referring to FIG. 12, in an alternative or additional aspect, at block 1202, the method 1100 may further include receiving a user selection of a selected route of the one or more safe routes, and periodically updating the GUI to include a current user location along the selected route. For example, in an aspect, user device 101, one or more processors 106, one or more memories 111, routing-function component 116, and/or receiving component 1040 may be configured to or may comprise means for receiving a user selection of a selected route of the one or more safe routes, and periodically updating the GUI to include a current user location along the selected route.

For example, the receiving at block 1202 may include a user transmitting, via the user device, a route selection, whereby the system can monitor conditions along the route in order to ensure that the route is the best route according to route criteria. Periodically updating the GUI to include a current user location can include the user device sending one or more messages including the current geographic location to the system. Such message(s) can be sent with a route request (e.g., a new route request or updated route request) and/or in response to a message from a server. In some aspects the GUI is updated according to a location determination by the user device, and the GUI displays the user location in accordance with a mapping program.

Further, for example, the receiving at block 1202 may be performed in order for the route determination system to modify and/or update a route calculation. This can inform the system of where the user is currently located and where they want to travel to, so that the system can make calculations and/or determinations about what routes are accessible to the user. In some aspects, updates can occur based on changing conditions (e.g., physical conditions such as weather, traffic, blocked routes, or electronic conditions such as one or more security devices malfunctioning and/or going offline along the route). Messages, notifications, and/or other updates can be configured to update the user about the route conditions based on triggers such as time, location, condition changes and/or others.

In an alternative or additional aspect, the one or more security devices includes at least one of a public video camera or a private video camera.

In an alternative or additional aspect, the security device data includes one or more of a line of sight, a focal length, a working distance, a lens magnification, an imaging sensor size, imaging sensor aspect ratio, or a field of view.

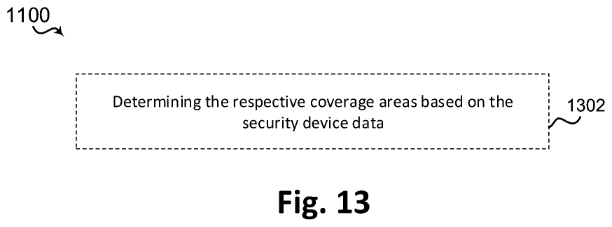

Referring to FIG. 13, in an alternative or additional aspect, at block 1302, the method 1100 may further include determining the respective coverage areas based on the security device data. For example, in an aspect, user device 101, one or more processors 106, one or more memories 111, routing-function component 116, and/or determining component 1045 may be configured to or may comprise means for determining the respective coverage areas based on the security device data.

For example, the determining at block 1302 may include using security device data to determine one or more security coverage areas. For example, certain types of security cameras may be able to capture accurate video recordings at a short distance and may constantly record, while others may record only periodically (e.g., one second of every ten seconds) but may have a longer field of view with accurate recording. In some aspects, multiple security devices can cover a single area, such that their coverage partially or fully overlaps.

Further, for example, the determining at block 1302 may be performed to ensure the best security coverage, because an outage or downtime due to a malfunction or other problem or issue with one security device will not cause a full outage and lack of surveillance of an area.

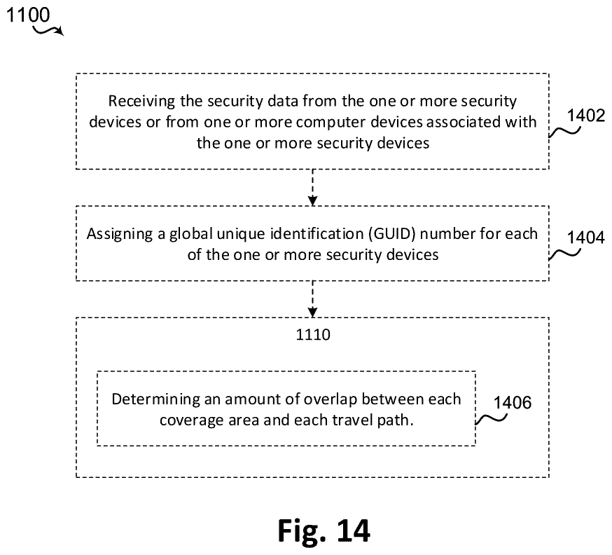

Referring to FIG. 14, in an alternative or additional aspect, at block 1402, the method 1100 may further include receiving the security data from the one or more security devices or from one or more computer devices associated with the one or more security devices. For example, in an aspect, user device 101, one or more processors 106, one or more memories 111, routing-function component 116, and/or receiving component 1045 may be configured to or may comprise means for receiving the security data from the one or more security devices or from one or more computer devices associated with the one or more security devices.

For example, the receiving at block 1402 may include receiving the security data from the one or more security devices, whereby the one or more security devices are directly and/or indirectly communicatively coupled with the system such that they can directly transmit security data to the system. In some aspects, this can include receiving signals and/or indicators such as “live” and/or active indicators, receiving video and/or audio feed information, and/or others.

In some aspects, receiving at block 1402 may include receiving security data from one or more computer devices such as user devices. In such aspects, a user can upload security data corresponding to one or more security devices to the system. This can occur, for example, when a user identifies a security device by sight. If the user knows security device information, they can input such information and upload it. Alternatively or additionally, a user could be an employee of a building or security system installation company. In such aspects, the user can upload security device information about one or more devices as part of their normal work duties. Such security device information can include locations, times of operation, field of view, direction, and/or other capabilities, features, and/or functions.

Further, for example, the receiving at block 1402 may be performed in order to maintain and/or grow one or more database(s) including security device data information.

In this optional aspect, at block 1404, the method 1100 may further include assigning a global unique identification (GUID) number for each of the one or more security devices. For example, in an aspect, user device 101, one or more processors 106, one or more memories 111, routing-function component 116, and/or assigning component 1050 may be configured to or may comprise means for assigning a global unique identification (GUID) number for each of the one or more security devices.

For example, the assigning at block 1404 may include assigning a GUID for each of the one or more security devices by determining if the next in a sequence of GUID's has been assigned, by assigning based on a characteristic of a security device (e.g., a manufacturer, owner, product line, type of device, function, or others), by assigning based on a geographic location, or others.

Further, for example, the assigning at block 1404 may be performed so that information about each security device is individually stored and can be updated, modified, and/or removed.

In this optional aspect, at block 1406, the identifying at block 1110 of one or more safe routes among the one or more travel paths further includes determining an amount of overlap between each coverage area and each travel path.

For example, certain types of security cameras may be able to capture accurate video recordings at a short distance and may constantly record, while others may record only periodically (e.g., one second of every ten seconds) but may have a longer field of view with accurate recording. In some aspects, multiple security devices can cover a single area, such that their coverage partially or fully overlaps. Overlapping coverage can be desirable in some instances, since malfunctioning or non-functioning of a security device could create a “hole” in coverage. Thus, multiple devices can provide better surveillance of a location, and may provide additional advantages, such as multiple angles.

In this optional aspect, at block 1408, the determining at block 1406 of an amount of overlap between each coverage area and each travel path further includes calculating a coverage ratio based on a sum of each amount of overlap associated with each travel path and a total path length of each travel path, calculating a rank of each travel path based on each respective coverage ratio, and wherein the identification information includes the rank

For example, ranking can be used to present travel path options to a user so that the user can make an informed decision as to which travel path they wish to follow. To elaborate, for some users a short path with low coverage may be less desirable than a longer path with more coverage. Alternatively, for some users a short path with low coverage may be more desirable than a longer path with more coverage.

In an alternative or additional aspect, the one or more computer devices are associated with a security device manufacturing company, a public individual, or a mapping application.

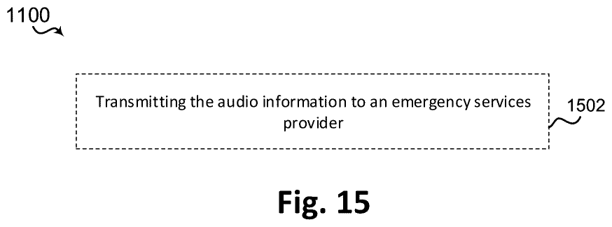

Referring to FIG. 15, in an alternative or additional aspect wherein the security data is audio information that includes one or more of a recording and information about recording equipment, at block 1502, the method 1100 may further include transmitting the audio information to an emergency services provider. For example, in an aspect, user device 101, one or more processors 106, one or more memories 111, routing-function component 116, and/or transmitting component 1040 may be configured to or may comprise means for transmitting the audio information to an emergency services provider.

For example, the transmitting at block 1502 may include transmitting an audio recording and/or information about audio recording equipment that is stored in memory and/or a database via a network.

Further, for example, the transmitting at block 1502 may be performed in order to provide an accurate understanding of surveillance capabilities. This can also be performed in order to for personnel such as police or other investigators to review the audio recording(s) in the event an incident has occurred that has been recorded.

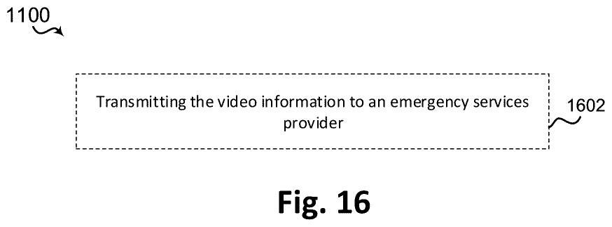

Referring to FIG. 16, in an alternative or additional aspect wherein the security data is video information, comprising that includes one or more of a recording and information about recording equipment, at block 1602, the method 1100 may further include transmitting the video information to an emergency services provider. For example, in an aspect, user device 101, one or more processors 106, one or more memories 111, routing-function component 116, and/or transmitting component 1040 may be configured to or may comprise means for transmitting the video information to an emergency services provider.

For example, the transmitting at block 1602 may include transmitting a video recording and/or information about video recording equipment that is stored in memory and/or a database via a network.

Further, for example, the transmitting at block 1602 may be performed may be performed in order to provide an accurate understanding of surveillance capabilities. This can also be performed in order to for personnel such as police or other investigators to review the audio recording(s) in the event an incident has occurred that has been recorded.

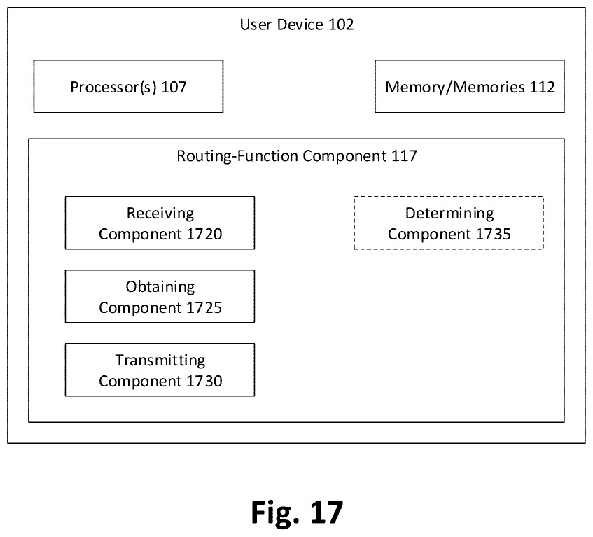

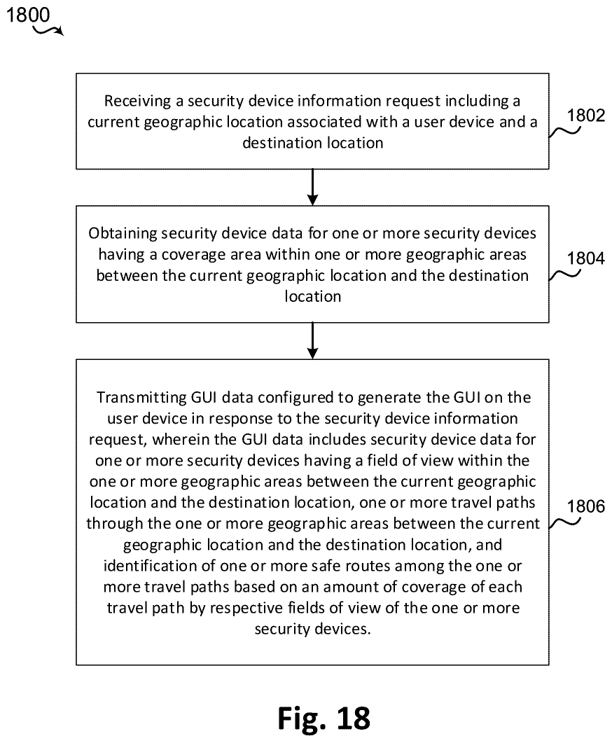

Referring to FIG. 17 and FIG. 18, in operation, user device 102 may perform a method 1800 of generating a graphical user interface (GUI), such as via execution of routing-function component 117 by one or more processors 107 and/or one or more memories 112.

At block 1802, the method 1800 includes receiving a security device information request including a current geographic location associated with a user device and a destination location. For example, in an aspect, user device 102, one or more processors 107, one or more memories 112, routing-function component 117, and/or receiving component 1720 may be configured to or may comprise means for receiving a security device information request including a current geographic location associated with a user device and a destination location.

For example, the receiving at block 1802 may include receiving, via a network, a security device information request from a user device or other device and can include a current geographic location associated with the user device and a destination location.

Further, for example, the receiving at block 1802 may be performed in order for the system to accurately determine one or more travel paths to respond to the user request.

At block 1804, the method 1800 includes obtaining security device data for one or more security devices having a coverage area within one or more geographic areas between the current geographic location and the destination location. For example, in an aspect, user device 102, one or more processors 107, one or more memories 112, routing-function component 117, and/or obtaining component 1725 may be configured to or may comprise means for obtaining security device data for one or more security devices having a coverage area within one or more geographic areas between the current geographic location and the destination location.

For example, the obtaining at block 1804 may include sending a request to a database and/or otherwise accessing a database or other security device information storage location. The database or security device information storage location can be stored locally or remotely and may be accessed via a network. Further, the database or security device information storage location can be provided by a third-party service (e.g., public, private, commercial, governmental, or others) in some aspects, can be maintained by the system in some aspects, or otherwise be accessible. Security device data can include information about security devices such as physical locations, height, field of view, direction of view, audio monitoring capabilities, sensor information (e.g., night vision, thermal vision, spectrum information, and/or others).

Further, for example, the obtaining at block 1804 may be performed in order for the system to accurately determine one or more travel paths to respond to the user request.

At block 1806, the method 1800 includes transmitting GUI data configured to generate the GUI on the user device in response to the security device information request, wherein the GUI data includes security device data for one or more security devices having a field of view within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective fields of view of the one or more security devices. For example, in an aspect, user device 102, one or more processors 107, one or more memories 112, routing-function component 117, and/or transmitting component 1730 may be configured to or may comprise means for transmitting GUI data configured to generate the GUI on the user device in response to the security device information request, wherein the GUI data includes security device data for one or more security devices having a field of view within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective fields of view of the one or more security devices.

For example, the transmitting at block 1806 may include transmitting GUI data from a route calculation system in response to the route request using a transmitter and/or transceiver via a wired and/or wireless network. GUI data can include map data associated with one or more geographic areas between the current geographic location and the destination location. Map data can include information about geographic and/or other physical features existing in the physical world such as streets, paths, tracks, terrain, elevation, paving, and/or others. GUI data can also include security device data for one or more security devices having a coverage area within the one or more geographic areas between the current geographic location and the destination location. Security device data can include information about security devices such as physical locations, height, field of view, direction of view, audio monitoring capabilities, sensor information (e.g., night vision, thermal vision, spectrum information, and/or others). GUI data can also include one or more travel paths through the one or more geographic areas between the current geographic location and the destination location. Travel path information can include artificial (e.g., human produced) routes, natural routes, and/or combinations thereof. Travel path information can also include description and/or naming of any obstacles that may be encountered along the travel path (e.g., streams, statues, hills, and/or others). GUI data can also include identification of one or more safe routes among the one or more travel paths based on an amount of coverage of each travel path by respective coverage areas of the one or more security devices. Identification information indicating the one or more safe routes can include identification information about one or more security devices along and/or pointing in the direction or otherwise monitoring and/or capable of monitoring the travel paths. For example, public and/or private surveillance cameras, audio surveillance equipment, electronic surveillance equipment (e.g., monitoring communications and/or other radio spectrum devices), wind sensors, temperature sensors, humidity sensors, smoke sensors, fire sensors, and/or others.

Further, for example, the transmitting at block 1806 may be performed in order to provide a user with accurate information about security device coverage in response to the user's route request.

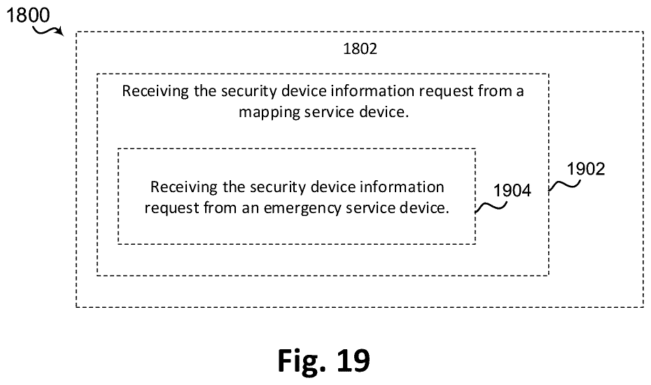

Referring to FIG. 19, in an alternative or additional aspect, at block 1902, the receiving at block 1802 of the security device information request comprises receiving the security device information request from a mapping service device.

For example, receiving the security device information from a mapping service device can occur if the mapping service device has access to one or more databases including security device information. Alternatively or additionally, the mapping service device can track or maintain a log or database of security devices that it updates based on automated, semi-automated, and/or manual recognition.

In this optional aspect, at block 1904, the receiving at block 1902 of the security device information request comprises receiving the security device information request from an emergency service device.

For example, an emergency service device could be maintained by firefighting, emergency medical services, police, or other public or private emergency services providers. Such providers may have access to and/or knowledge of security device information.

In an alternative or additional aspect, the GUI includes coverage area representations of the one or more security devices on the one or more safe routes.

In an alternative or additional aspect, the GUI includes a security score indicator for each of the one or more safe routes respectively, based on the amount of coverage of each travel path by the respective coverage areas of the one or more security devices. In this aspect, the GUI may include security device representations of the one or more security devices on the one or more geographic areas between the current geographic location and the destination location. In this aspect, the security device representations may include security device information. In this aspect, the security device information may include at least one of a geographic location information, a global unique identification (GUID) number, or non-personal identifier information associated with each respective security device.

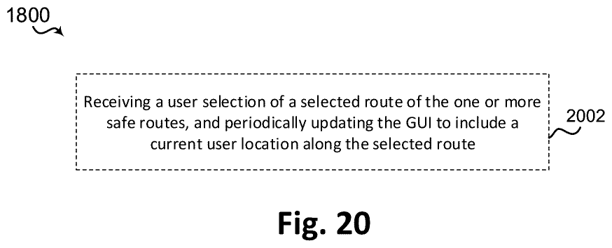

Referring to FIG. 20, in an alternative or additional aspect, at block 2002, the method 1800 may further include receiving a user selection of a selected route of the one or more safe routes, and periodically updating the GUI to include a current user location along the selected route. For example, in an aspect, user device 102, one or more processors 107, one or more memories 112, routing-function component 117, and/or receiving component 1730 may be configured to or may comprise means for receiving a user selection of a selected route of the one or more safe routes, and periodically updating the GUI to include a current user location along the selected route.

For example, the receiving/updating at block 2002 may include receiving a user selection of a selected route when the user has chosen which a route to take. Periodically updating the GUI can be performed in order to provide accurate information as the user travels along the selected route.

Further, for example, the receiving/updating at block 2002 may be performed in order for the system to provide an accurate representation of their location along the selected route.

In an alternative or additional aspect, the one or more security devices includes at least one of a public video camera or a private video camera.

In an alternative or additional aspect, the security device data includes one or more of a line of sight, a focal length, a working distance, a lens magnification, an imaging sensor size, imaging sensor aspect ratio, or a field of view.

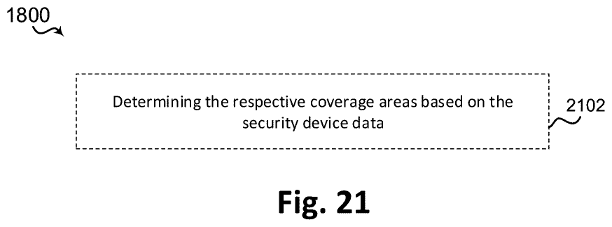

Referring to FIG. 21, in an alternative or additional aspect, at block 2102, the method 1800 may further include determining the respective coverage areas based on the security device data. For example, in an aspect, user device 102, one or more processors 107, one or more memories 112, routing-function component 117, and/or determining component 1735 may be configured to or may comprise means for determining the respective coverage areas based on the security device data.

For example, the determining at block 2102 may include security device data, which can include technical features and capabilities of security devices.

Further, for example, the determining at block 2102 may be performed for the system to be able to provide an accurate surveillance understanding based on the security device capabilities and/or functions.

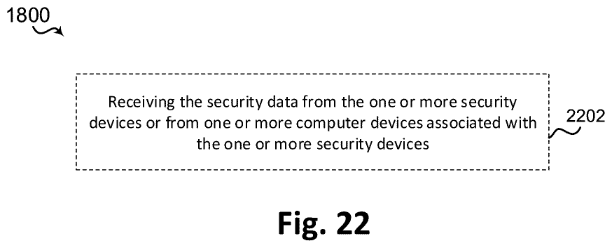

Referring to FIG. 22, in an alternative or additional aspect, at block 2202, the method 1800 may further include receiving the security data from the one or more security devices or from one or more computer devices associated with the one or more security devices. For example, in an aspect, user device 102, one or more processors 107, one or more memories 112, routing-function component 117, and/or receiving component 1735 may be configured to or may comprise means for receiving the security data from the one or more security devices or from one or more computer devices associated with the one or more security devices.

For example, the receiving at block 2202 may include receiving security data from the security devices via a network.

Further, for example, the receiving at block 2202 may be performed in order for an accurate surveillance feed to be reviewed and/or stored.

In an alternative or additional aspect, the one or more computer devices are associated with a security device manufacturing company, a member of the public, or a mapping application.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. An apparatus for generating a graphical user interface (GUI), comprising:
one or more memories; and
one or more processors coupled with the one or more memories and configured, individually or in combination, to:
receive destination information associated with a destination location;
determine a current geographic location;
transmit a route request including the current geographic location and the destination location;
receive GUI data in response to the route request, wherein the GUI data includes map data associated with one or more geographic areas between the current geographic location and the destination location, security device data for one or more security devices having a coverage area within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective coverage areas of the one or more security devices; and
present the GUI on a display device, wherein the GUI includes a map representation based on the map data and one more safe route representations corresponding to the identification of the one or more safe routes.

2. The apparatus of claim 1, wherein the GUI includes coverage area representations of the one or more security devices on the one or more safe route representations.

3. The apparatus of claim 1, wherein the GUI includes a security score indicator for each of the one or more safe route representations respectively, based on the amount of coverage of each travel path by the respective coverage areas of the one or more security devices.

4. The apparatus of claim 3, wherein the GUI includes security device representations of the one or more security devices on the one or more geographic areas between the current geographic location and the destination location.

5. The apparatus of claim 4, wherein the security device representations include security device information.

6. The apparatus of claim 5, wherein the security device information includes at least one of a geographic location information, a global unique identification (GUID) number, or non-personal identifier information associated with each respective security device.

7. The apparatus of claim 1, wherein the one or more processors are further configured to receive a user selection of a selected route of the one or more safe routes, and periodically updating the GUI to include a current user location along the selected route.

8. The apparatus of claim 1, wherein the one or more security devices includes at least one of a public video camera or a private video camera.

9. The apparatus of claim 1, wherein the security device data includes one or more of a line of sight, a focal length, a working distance, a lens magnification, an imaging sensor size, imaging sensor aspect ratio, or a field of view.

10. The apparatus of claim 9, wherein the one or more processors are further configured to determine the respective coverage areas based on the security device data.

11. The apparatus of claim 1, wherein the one or more processors are further configured to receive a coverage notification when in each coverage area or to receive a non-coverage notification when outside of each coverage area.

12. An apparatus for generating a graphical user interface (GUI), comprising:
one or more memories; and
one or more processors coupled with the one or more memories and configured, individually or in combination, to:
receive a route request including a current geographic location associated with a user device and a destination location;
obtain map information associated with one or more geographic areas between the current geographic location and the destination location;
obtain security device data for one or more security devices having a coverage area within the one or more geographic areas between the current geographic location and the destination location;
generate one or more travel paths through the one or more geographic areas between the current geographic location and the destination location;
identify one or more safe routes among the one or more travel paths based on an amount of coverage of each travel path by respective coverage areas of the one or more security devices; and
transmit GUI data configured to generate the GUI on the user device in response to the route request, wherein the GUI data includes map data associated with the one or more geographic areas between the current geographic location and the destination location, security device data for the one or more security devices having the coverage area within the one or more geographic areas between the current geographic location and the destination location, one or more travel paths through the one or more geographic areas between the current geographic location and the destination location, and identification information indicating the one or more safe routes among the one or more travel paths based on the amount of coverage of each travel path by the respective coverage areas of the one or more security devices.

13. The apparatus of claim 12, wherein the GUI includes coverage area representations of the one or more security devices on the one or more safe routes.

14. The apparatus of claim 12, wherein the GUI includes a security score indicator for each of the one or more safe routes respectively, based on the amount of coverage of each travel path by the respective coverage areas of the one or more security devices.

15. The apparatus of claim 14, wherein the GUI includes security device representations of the one or more security devices on the one or more geographic areas between the current geographic location and the destination location.

16. The apparatus of claim 15, wherein the security device representations include security device information.

17. The apparatus of claim 16, wherein the security device information includes at least one of a geographic location information, a global unique identification (GUID) number, or non-personal identifier information associated with each respective security device.

18. The apparatus of claim 12, wherein the one or more processors are further configured to receive a user selection of a selected route of the one or more safe routes, and periodically updating the GUI to include a current user location along the selected route.

19. The apparatus of claim 12, wherein the one or more security devices includes at least one of a public video camera or a private video camera.

20. The apparatus of claim 12, wherein the security device data includes one or more of a line of sight, a focal length, a working distance, a lens magnification, an imaging sensor size, imaging sensor aspect ratio, or a field of view.

21. The apparatus of claim 20, wherein the one or more processors are further configured to determine the respective coverage areas based on the security device data.

22. The apparatus of claim 12, wherein the one or more processors are further configured to receive the security data from the one or more security devices or from one or more computer devices associated with the one or more security devices.

23. The apparatus of claim 22, wherein the one or more processors are further configured to assign a global unique identification (GUID) number for each of the one or more security devices.

24. The apparatus of claim 23, wherein to identify one or more safe routes among the one or more travel paths the one or more processors are further configured to:
determine an amount of overlap between each coverage area and each travel path.

25. The apparatus of claim 24, wherein to determine an amount of overlap between each coverage area and each travel path the one or more processors are further configured to:
calculate coverage ratio based on sum of each amount of overlap associated with each travel path and a total path length of each travel path, calculating a rank of each travel path based on each respective coverage ratio, and wherein the identification information includes the rank.

26. The apparatus of claim 22, wherein the one or more computer devices are associated with a security device manufacturing company, a public individual, or a mapping application.

27. The apparatus of claim 22, wherein the security data is audio information that includes one or more of a recording and information about recording equipment, and wherein the one or more processors are further configured to:
transmit the audio information to an emergency services provider.

28. The apparatus of claim 22, wherein the security data is video information that includes one or more of a recording and information about recording equipment, and wherein the one or more processors are further configured to:
transmit the video information to an emergency services provider.

29. An apparatus for generating a graphical user interface (GUI), comprising:
one or more memories; and
one or more processors coupled with the one or more memories and configured, individually or in combination, to:
receive a security device information request including a current geographic location associated with a user device and a destination location;
obtain security device data for one or more security devices having a coverage area within one or more geographic areas between the current geographic location and the destination location;
transmit GUI data configured to generate the GUI on the user device in response to the security device information request, wherein the GUI data includes security device data for one or more security devices having a field of view within the one or more geographic areas between the current geographic location and the destination location, one or more travel paths through the one or more geographic areas between the current geographic location and the destination location, and identification of one or more safe routes among the one or more travel paths based on an amount of coverage of each travel path by respective fields of view of the one or more security devices.

30. The apparatus of claim 29, wherein to receive the security device information request comprises to receive the security device information request from a mapping service device.

31. The apparatus of claim 30, wherein to receive the security device information request comprises to receive the security device information request from an emergency service device.

32. The apparatus of claim 29, wherein the GUI includes coverage area representations of the one or more security devices on the one or more safe routes.

33. The apparatus of claim 29, wherein the GUI includes a security score indicator for each of the one or more safe routes respectively, based on the amount of coverage of each travel path by the respective coverage areas of the one or more security devices.

34. The apparatus of claim 33, wherein the GUI includes security device representations of the one or more security devices on the one or more geographic areas between the current geographic location and the destination location.

35. The apparatus of claim 34, wherein the security device representations include security device information.

36. The apparatus of claim 35, wherein the security device information includes at least one of a geographic location information, a global unique identification (GUID) number, or non-personal identifier information associated with each respective security device.

37. The apparatus of claim 29, wherein the one or more processors are further configured to receive a user selection of a selected route of the one or more safe routes, and periodically updating the GUI to include a current user location along the selected route.

38. The apparatus of claim 29, wherein the one or more security devices includes at least one of a public video camera or a private video camera.

39. The apparatus of claim 29, wherein the security device data includes one or more of a line of sight, a focal length, a working distance, a lens magnification, an imaging sensor size, imaging sensor aspect ratio, or a field of view.

40. The apparatus of claim 39, wherein the one or more processors are further configured to determine the respective coverage areas based on the security device data.

41. The apparatus of claim 29, wherein the one or more processors are further configured to receive the security data from the one or more security devices or from one or more computer devices associated with the one or more security devices.

42. The apparatus of claim 41, wherein the one or more computer devices are associated with a security device manufacturing company, a member of the public, or a mapping application.
